(19) United States
(12) Patent Application Publication
(10) Pub. No.: US 2016/0019479 A1
(43) Pub. Date: Jan. 21, 2016

(54) Interactive and Iterative Behavioral Model, System, and Method for Detecting Fraud, Waste, and Abuse

(71) Applicant: Rebecca S. Busch, Clarendon Hills, IL (US)

(72) Inventor: Rebecca S. Busch, Clarendon Hills, IL (US)

(21) Appl. No.: 14/804,299

(22) Filed: Jul. 20, 2015

Related U.S. Application Data
(60) Provisional application No. 62/026,556, filed on Jul. 18, 2014.

(51) Int. Cl. G06Q 10/06

(52) U.S. Cl. CPC G06Q 10/0635

(57) ABSTRACT

An interactive, iterative, and/or reiterating behavioral model (FWA-IIRB) for detecting, preventing, and/or mitigating fraud, waste, and abuse in an industry is provided. The model is comprehensive and facilitates analysis of different types of fraud cases in different ways. For example, an approach may be determined by the nature of the industry. Likewise, the identity of a primary player identified by the system may at least in part determine the approach. The WA-IIRB model is comprehensive in data collection and effective in handling a wide variety of situations, players and industries. Simultaneously, the system builds data volume by creating additional data points and discovering gaps as the model/framework proceeds to final output/results. By tailoring the analysis algorithm to the type and content of the data provided to the system, the invention improves a computer's speed and efficiency in processing the data and supplying a result.

### CROSS REFERENCE TO RELATED APPLICATIONS

This application claims the benefit of U.S. provisional application No. 62/026,556, filed Jul. 18, 2014, the entire contents of which are hereby incorporated by reference.

### FIELD OF THE INVENTION

The present invention relates to a fraud, waste and abuse (FWA), risk and compliance interactive, iterative, and/or reiterating behavioral continuum model, framework, and analytic roadmap to identify, collect, authenticate, process, transform and/or unify fragmented data. (FWA-IIRB Model, Framework, and Analytic Roadmap).

### BACKGROUND

Abnormalities that result in fraud, waste and abuse are pervasive in the healthcare industry because ethically challenged individuals, groups and/or corporations abuse the system and then use deceptive tactics, techniques and procedures to avoid detection. This is compromised because the basic building blocks of deception manifest themselves as moving targets, compromising the ability to expose deceptive measures. The ability to pinpoint subterfuge is compromised by a significant lack of subject matter expertise; ineffective use and/or development of new and emerging algorithmic protocols; limited historical attributes; adversary knowledge of audit methods and tools and avoidance of areas under scope and review (the investigative metric is $1 M−steal/embezzled $0.9 M); a lack of internal controls within dynamic business environments; a lack of inventory management controls, creating a “needle in a haystack” environment; tools that use estimates versus targeting specific elements of fraud, waste and abuse; and predictive modeling versus extracting current active data points. Industry literature is rampant with instances of transaction errors, waste and criminal fraud. Illustrative examples: Medicare paid $25 million to deceased persons and $29 million in drug benefits for illegal immigrants from 2009 to 2011. A US government contract initiative pursued the development of a “fraud prevention system” that was established in 2011 as a predictive modeling program. This program provided limited results of $115 million dollars in Medicare claims that were either “stopped, prevented, or identified,” resulting in a 0.01% impact on the estimated 19% of Medicare spending that is lost due to fraud, waste and abuse. In essence, at least eighteen percent of Medicare spending is still lost to fraud, waste and abuse that circumvents existing controls and initiatives. The Association of Certified Fraud Examiners' “2014 Report to the Nation” reveals that occupational fraud may account for 5% of annual corporate revenues. Based on the 2013 estimated Gross World Product of $73.87 trillion, this projects a potential total global fraud loss of $3.7 trillion alone in this category of fraud. Counterfeiting, another category of fraud, is another pervasive issue. It does not appear that any industry is immune from counterfeit threat. An illustrative example of the scope of this niche fraudulent area can be found in a report by the International Anti-Counterfeiting Coalition. They report for the fiscal year 2013 that the Department of Homeland Security seized an estimated $1.7 billion in counterfeit goods at U.S. borders.

Government and private sector entities have deployed various initiatives and programs in order to attempt to combat fraud, waste and abuse. These initiatives are limited by their data analytic techniques and/or methods that are functionally disconnected and unorganized, lacking a holistic approach. Failure by government and private sector entities in the detection, mitigation and prevention of fraud, waste and abuse results from the use of tools that are narrowly focused on a limited range of data points, as opposed to incorporating varying levels of data that are situationally relevant. Today's standard approach involves using tools that are algorithm based. This type of strictly data-driven, algorithmic approach creates limitations due to its use as a linear, narrow, and/or exclusively analytically-driven tool that utilizes only fragments of data. Ethically challenged individuals prey on this use of fragmented data, using knowledge of fraud detection methods to give themselves the space to attack. This occurs because the user of the tools is starting off by using only a defined algorithm, meaning that they only gather certain points of information, narrowing down their input without first gathering an understanding of all of the existing data. As a result, current analytic methods fail to incorporate key metric components, including behavioral understanding, identification of all relevant fragmented data elements, and the collection, authentication, processing, and transformation of data elements using behavioral understanding. A holistic, all-inclusive finding is not possible without these key elements. Fragmented analysis and the use of limited algorithmic tools result in the misinterpretation of results and the failure to identify the etiology of fraud, waste and abuse. Fragmented or non-holistic analytic tools result in failure to detect, identify and define “real-time” data points that contribute to or completely mask the indications and warnings of: fraud, unacceptable risk, noncompliance, Activities of Daily Living flows (ADL's), Activities of Daily Work flows (ADW's) and corresponding Prevention, Detection and Mitigation work flows (PDM's). Fraud within traditional brick and mortar environments, coupled with criminal cyber enterprise activity, continues to flourish worldwide and remains embed within environments that lack systematic controls. Current market place tools that apply retrospective, prospective, and concurrent analytic fraud detection and prevention programs are hampered by technical limitations which narrow their scope and effectiveness at detecting fraud, waste and abuse.

A need therefore exists for a system and method that provides an analytical roadmap and a mechanism to mitigate inadequate, disconnected, un-unified, fragmented information while addressing personal bias and professional, political, psychosocial and socioeconomic conditions, allowing for a holistic “head-to-toe” approach to combating fraud, waste and abuse. The needed system and method should provide the assurance of appropriate data point capture, resulting in a highly stable fraud, waste and abuse detection tool. The execution, unification and combination of identified behavioral components should result in a mature outcome determination. A system and method is needed to bridge the method and tool gap currently encountered while employing existing systems, moving above and beyond the capabilities of current standards. A system is also needed that would allow a user to provide data input in a linear and non-sequential order.

### SUMMARY OF THE INVENTION

According to a system and method of the invention, a user is prompted to enter available and known behavioral components related to a case. The system includes a model run by a server that will start to analyze and process known components. The initial output will prompt the user to identify the remaining inputs required within six critical behavioral components, consisting of the “Player Component,” “Benchmark Component,” “Functional Informational Component,” “Rules-Based Component,” “Transparency Component,” and “Consequence Component.” When prompted by the system, the user may realize that she is missing data relating to one or more of the remaining inputs—thus learning of a “discoverable gap” that leads toward a conclusion of the investigation of the case. Alternatively, if the user provides the missing data in response to the prompt, the system will determine whether the supplemental data or any previously provided data is normal or abnormal in view of the new totality of data provided to the system, and whether any other data not yet obtained becomes expected in view of the new totality of data provided to the system. If new data becomes expected, the process is repeated in which the user either provides the missing data or is alerted to the discoverable gap, which may lead toward a conclusion of the investigation of the case. Likewise, if the system alerts the user to an abnormal data point, the discovery of the abnormal data point may lead toward a conclusion of the investigation of the case.

### BRIEF DESCRIPTION OF THE DRAWINGS

FIG. 1 is an illustration of a methodology designed to provide a comprehensive outcome determination driven by a continuum of six critical behavioral components, consisting of the “Player Component,” “Benchmark Component,” “Functional Informational Component,” “Rules-Based Component,” “Transparency Component,” and “Consequence Component.”

FIG. 2 is an illustration of a skeletal structure designed to support the methodological process includes data components required for a comprehensive outcome determination driven by six critical behavioral components: “Players Component,” “Benchmarks Component,” “Functional Information Component,” “Rules-Based Component,” “Transparency Component” and “Consequence Component.”

FIG. 3 is an illustration of data drivers or the mechanical data (fact(s), statistic(s), code(s), items of information and data) that create and fuel activity, collection, unification, analysis and/or computations resulting in a comprehensive, unified final output within the inventions FWA-IIRB Model, Framework, and Analytic Roadmap.

FIG. 4 is an illustration of a framework that incorporates the methodology, of FIG. 1, skeletal structure of FIG. 2, and data drivers of FIG. 3 to provide the mechanism for an output determination of the Fraud, Waste and Abuse (FWA), Risk and Compliance Interactive, Iterative, and Reiterating Behavioral Continuum Model, Framework, and Analytic Roadmap in order to identify, collect, authenticate, transform and/or unify fragmented data.

FIG. 5 depicts an illustrative banking industry revenue cycle that may be modeled and investigated using the model and framework set forth in FIGS. 1-4.

FIG. 6 is a schematic illustration of a system infrastructure that operates the model and framework set forth in FIGS. 1-4.

FIG. 7A is a representative screenshot of a user interface displayed by the infrastructure of FIG. 6 to operate the model and framework set forth in FIGS. 1-4.

FIG. 7B is another representative screenshot of a user interface displayed by the infrastructure of FIG. 6 to operate the model and framework set forth in FIGS. 1-4.

FIG. 7C is another representative screenshot of a user interface displayed by the infrastructure of FIG. 6 to operate the model and framework set forth in FIGS. 1-4.

FIG. 7D is another representative screenshot of a user interface displayed by the infrastructure of FIG. 6 to operate the model and framework set forth in FIGS. 1-4.

FIG. 7E is another representative screenshot of a user interface displayed by the infrastructure of FIG. 6 to operate the model and framework set forth in FIGS. 1-4.

FIG. 7F is another representative screenshot of a user interface displayed by the infrastructure of FIG. 6 to operate the model and framework set forth in FIGS. 1-4.

FIG. 7G is another representative screenshot of a user interface displayed by the infrastructure of FIG. 6 to operate the model and framework set forth in FIGS. 1-4.

FIG. 7H is another representative screenshot of a user interface displayed by the infrastructure of FIG. 6 to operate the model and framework set forth in FIGS. 1-4.

FIG. 7I is another representative screenshot of a user interface displayed by the infrastructure of FIG. 6 to operate the model and framework set forth in FIGS. 1-4.

FIG. 7J is another representative screenshot of a user interface displayed by the infrastructure of FIG. 6 to operate the model and framework set forth in FIGS. 1-4.

### DETAILED DESCRIPTION OF THE INVENTION

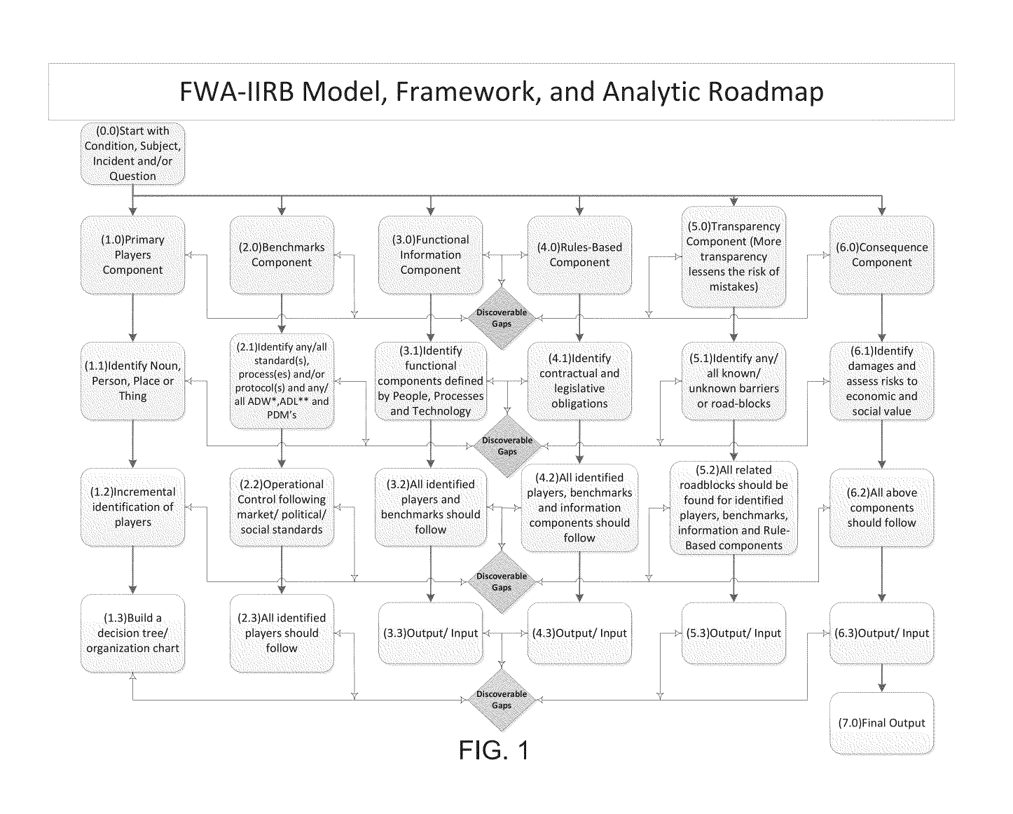

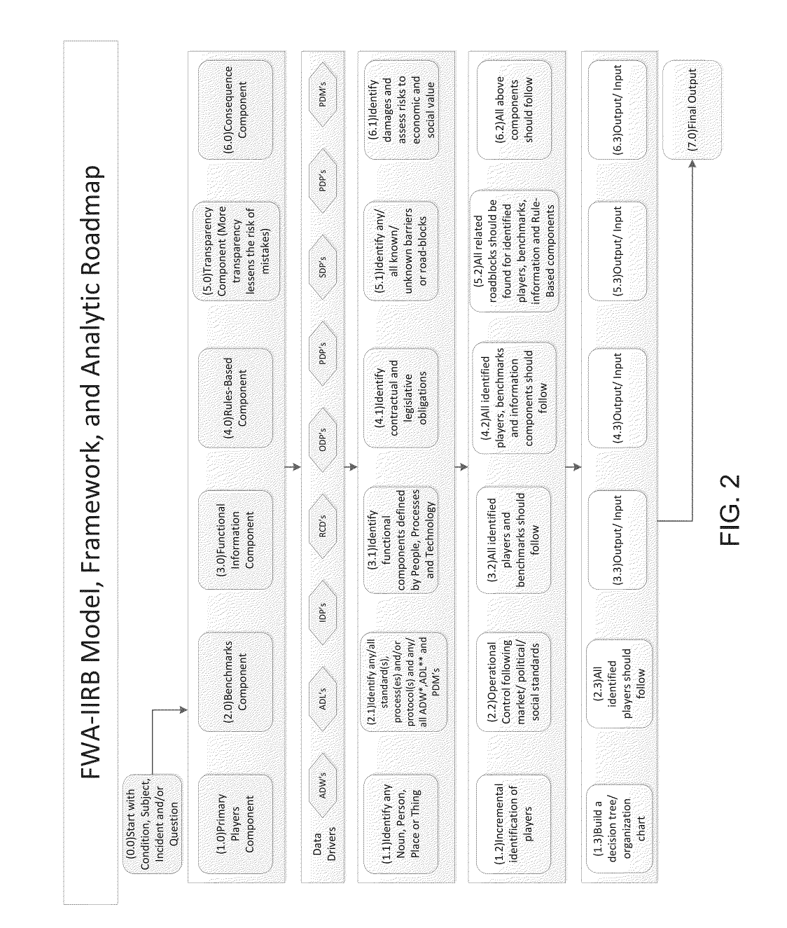

This invention, the FWA-IIRB Model and Framework, establishes an analytical roadmap, a mechanism to mitigate inadequate, disconnected, un-unified, fragmented information while addressing personal bias and professional, political, psychosocial and socioeconomic conditions, allowing for a holistic “head-to-toe” approach to combating fraud, waste and abuse. The FWA-IIRB Model and Framework provides the assurance of appropriate data point capture, resulting in a highly stable fraud, waste and abuse detection tool. The execution, unification and combination of identified behavioral components results in a mature outcome determination. The FWA-IIRB Model, Framework, and Analytic Roadmap bridges the current method and tool gap encountered while employing the contemporary systems available, moving above and beyond the capabilities of current standards. The roadmap component allows the user to provide data input in a linear (FIG. 1) and non-sequential order (FIG. 2). The user will be prompted to enter available and known components; the model will start to analyze and process known components; the initial out will prompt the user to identify the remaining inputs required within the identified six behavioral components.

In accordance with a system depicted schematically in FIGS. 1-4, behaviors critical to the analysis or investigation of a plan, process, or subject are identified within a behavior continuum including components set forth in the next paragraph. “Behavior” may refer to responses, actions, reactions, or functioning of parties or players within a system, or to those of the system itself, and may be subject to certain conditions or specific to certain industries or types of organized activity. For example, a particular industry or type of organized activity may have a characteristic or typical revenue cycle that defines parameters of an investigation and/or analysis performed in accordance with a system or method according to the invention.

Behavioral continuum components according to the invention may be defined as a Player Component, a Benchmark Component, a Functional Information Component, a Rules-Based Component, a Transparency/Opaqueness/Obstruction Component, and a Consequence Component. A Player is a person, place, or thing that takes part in an industry or organized activity under examination. A Benchmark may be an attribute of a Player, such as that player's standard, point of reference, and/or measurement. A Benchmark may also refer to a standard, point of reference, or measurement within and/or among each other component within the behavioral continuum. Functional Information refers to all relational knowledge derived by persons, communication systems, circumstances, research, processes, technology, and/or behaviors realized by each identified player, as well as within and/or among the other components within the behavioral continuum. A Rules-Based Component may refer to any related rule, principle, or regulation governing conduct, actions, procedures, and arrangements, or to contracts, legislation, or dominion and control generated by each identified player, or existing within and/or among the other components of the behavioral continuum. Transparency/Opaqueness/Obstruction refers to the degree of openness and accessibility, inaccessibility, or even resistance to access of information of or relating to players or other behavioral continuum components. A Consequence Component relates to a result, effect, importance, or significance of each player or their actions and/or of the other behavioral continuum components.

A model for the behavioral continuum is specified. The model may be a standard, plan, example for imitation, comparison, design, pattern, mode of structure or formation within or among the behavioral continuum components. The model is a kind of framework or skeletal structure within which the behavioral continuum components are analyzed.

In conjunction with the model, an analytical roadmap is also provided, as a guide to arrange data points, create a plan, and/or accomplish or determine an outcome within the skeletal structure of the model. Data that drive the model/framework and roadmap may include data generated by each identified player and/or within or among the other behavioral continuum components.

“Flow” as used herein refers to movement (for example, of data or other matter) within or among behavioral continuum components.

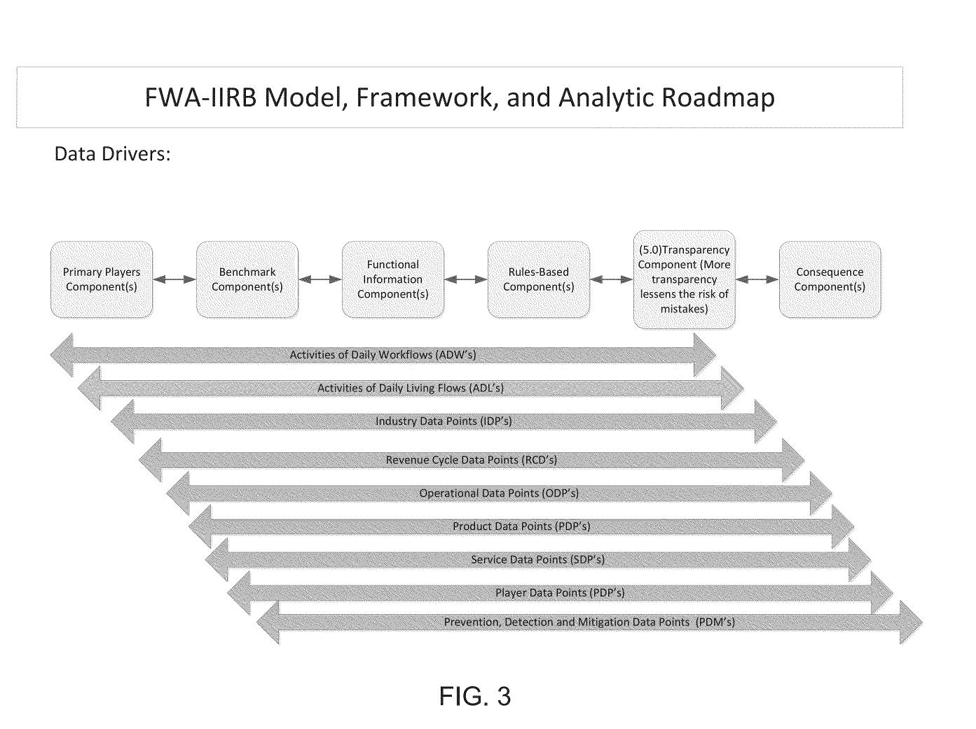

With reference to FIG. 3, data collected and analyzed by the system and method of the invention may be of a widely varying nature and may represent a wide variety of real-world subject matter, including activities of daily workflows (ADW's), activities of daily living flows (ADL), industry data points (IDP's), revenue cycle data points (RCD's), operational data points (ODP's), product data points (PrDP's), service data points (SDP's), player data points (PIDP's), and prevention, detection, mitigation data points (PDM's).

Specifications are defined for assessment and management of fraud, waste, and abuse (FWA), risk assessment and management, compliance assessment and management. As used herein, “risk” will be understood to encompass exposure to chance of injury, loss, hazard, and/or noncompliance.

The model and framework incorporates data drivers defined in FIG. 3 as a key distinction within and/or among the FWA-IIRB Model, Framework, and Analytic Roadmap. The model and framework is driven by isolating “normal” data driver components within the FWA-IIRB Model, Framework, and Analytic Roadmap. The exceptions are “abnormal,” resulting in discoverable gaps that facilitate the FWA-IIRB Model, Framework, and Analytic Roadmap. The abnormal gaps derived will channel prevention, detection and mitigation work flows within the FWA-IIRB Model, Framework, and Analytic Roadmap (FIGS. 1-5). This invention is unique in that it provides an interactive, iterative, and/or reiterative behavioral methodology to complete the required data point, comprehensively identifying, assessing, and analyzing gaps leading towards an outcome determination. FWA-IIRB Model, Framework, and Analytic Roadmap avoids fragmented and compromised outcome determinations.

### EXAMPLE

### Identity Theft—Sample Components from One Issue in a Case

In the following simplified example, the actions described as being performed by a “computer system” are at least in part performed by a computer processor executing instructions stored on a computer readable storage medium. The example relates to a fraud victim, a female spouse in the process of getting divorced, who attempts to open up a checking account to deposit cash. The bank refused to open an account. The victim runs a credit report with a reported score of 358:

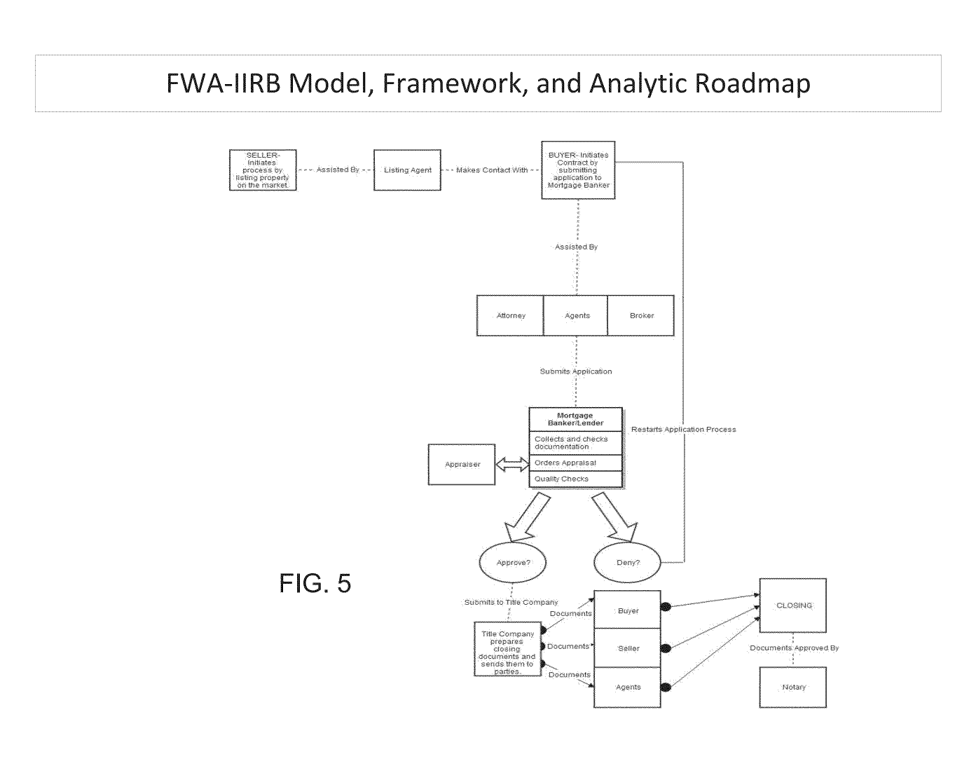

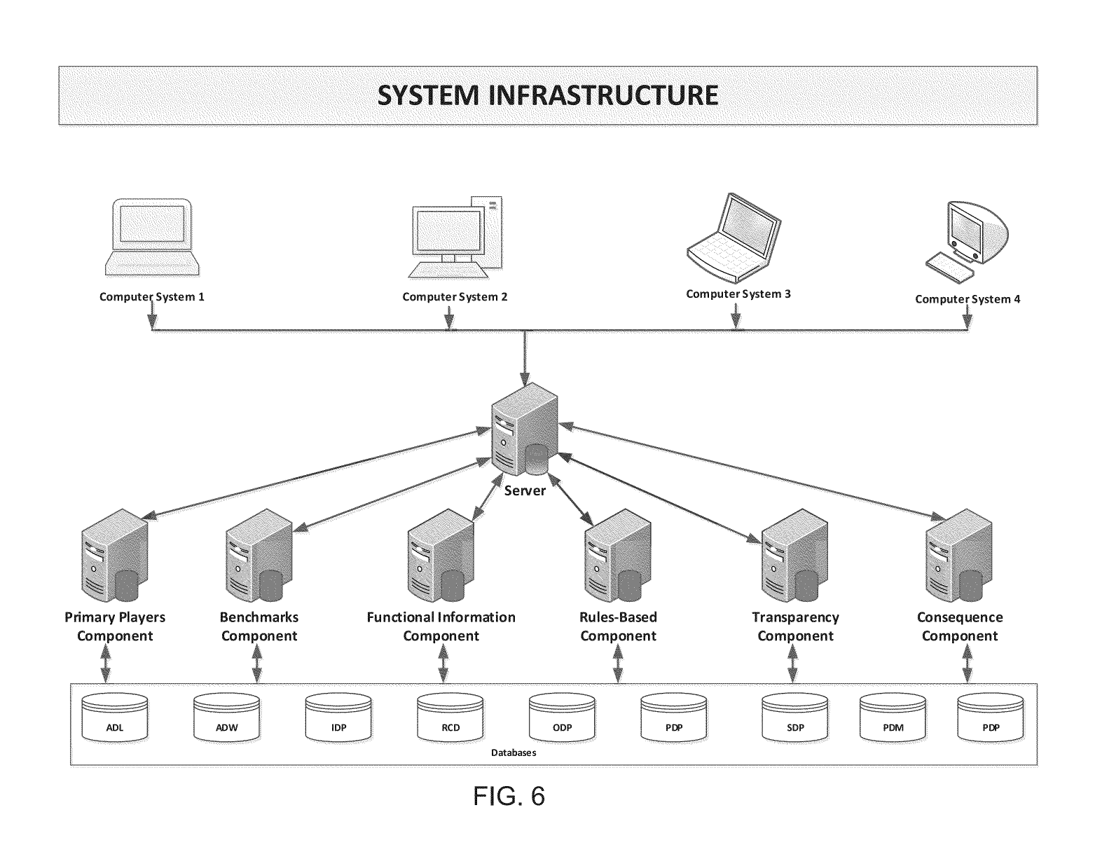

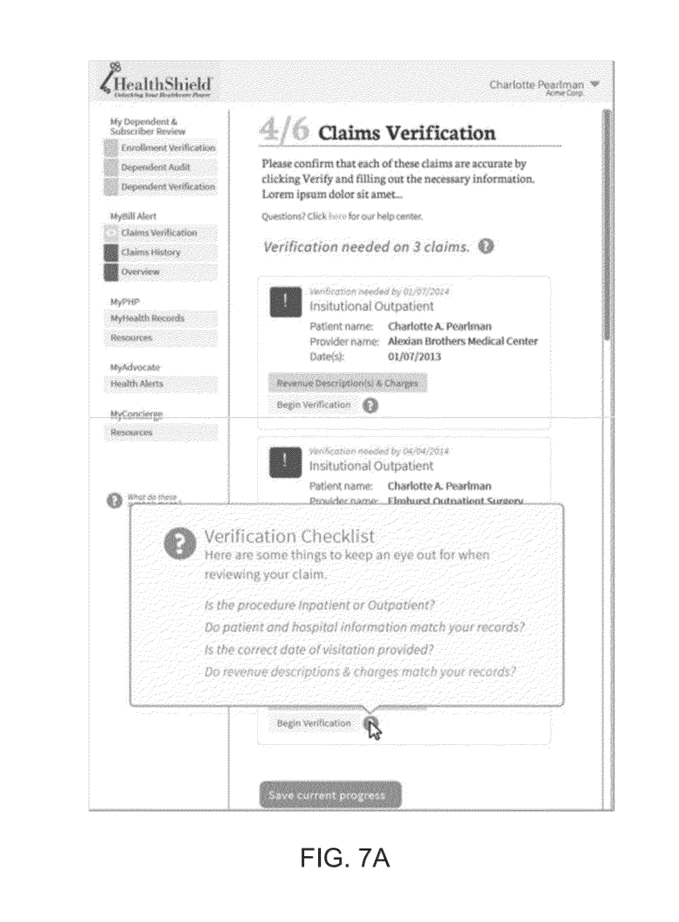

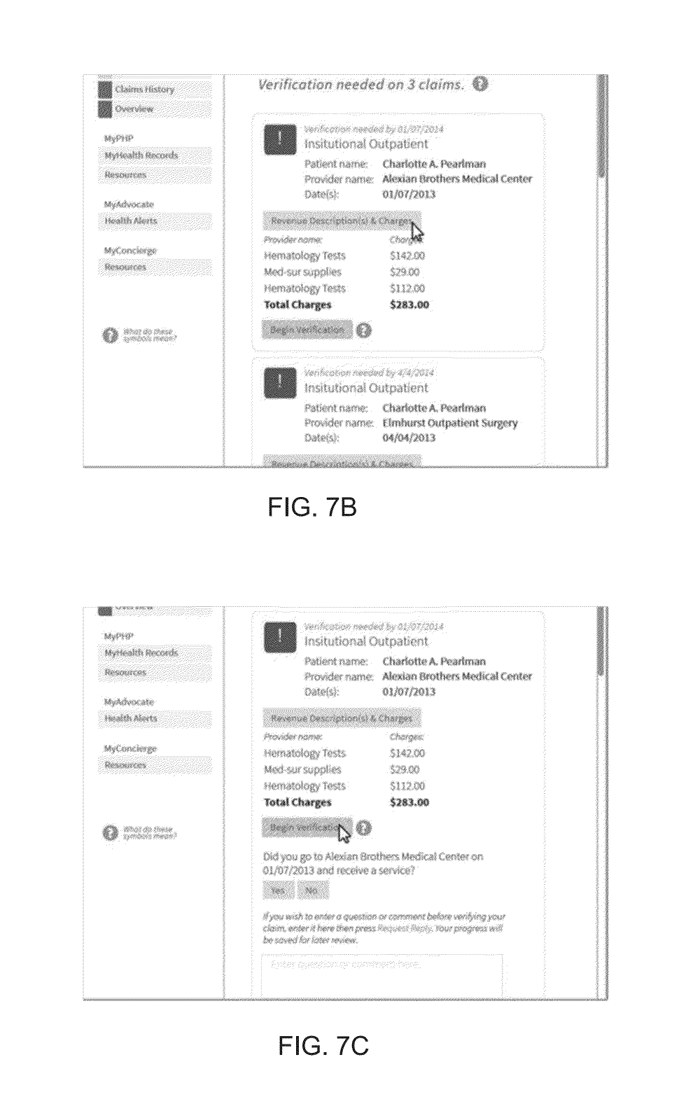

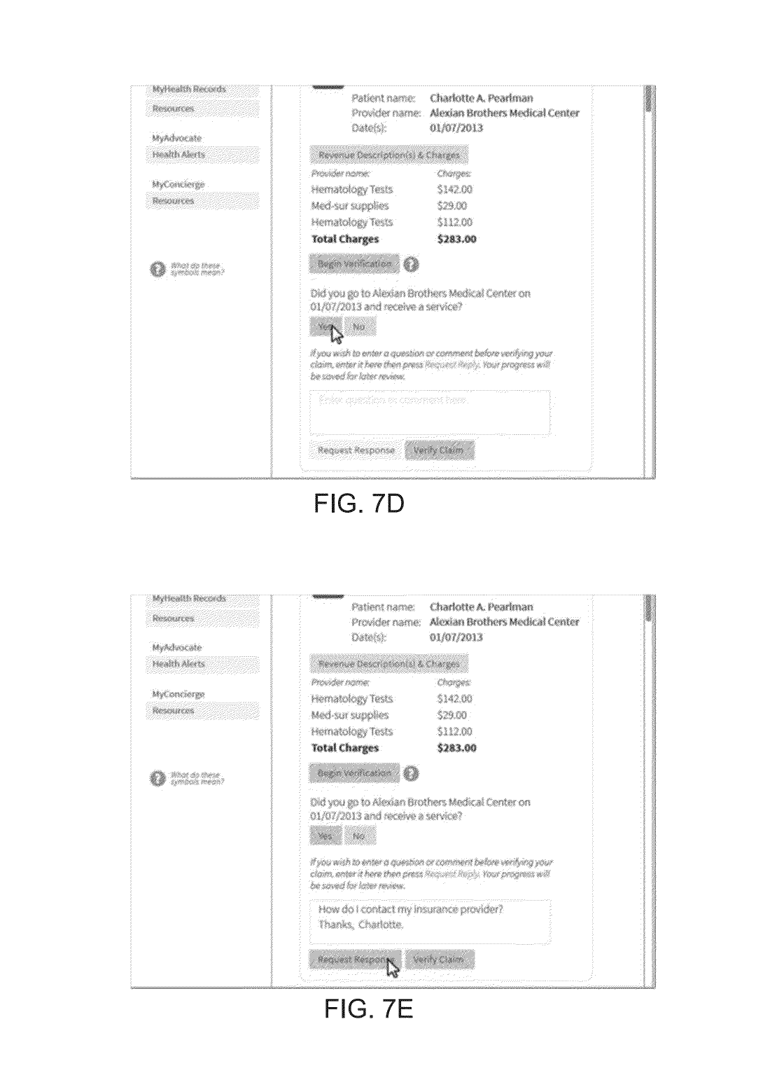

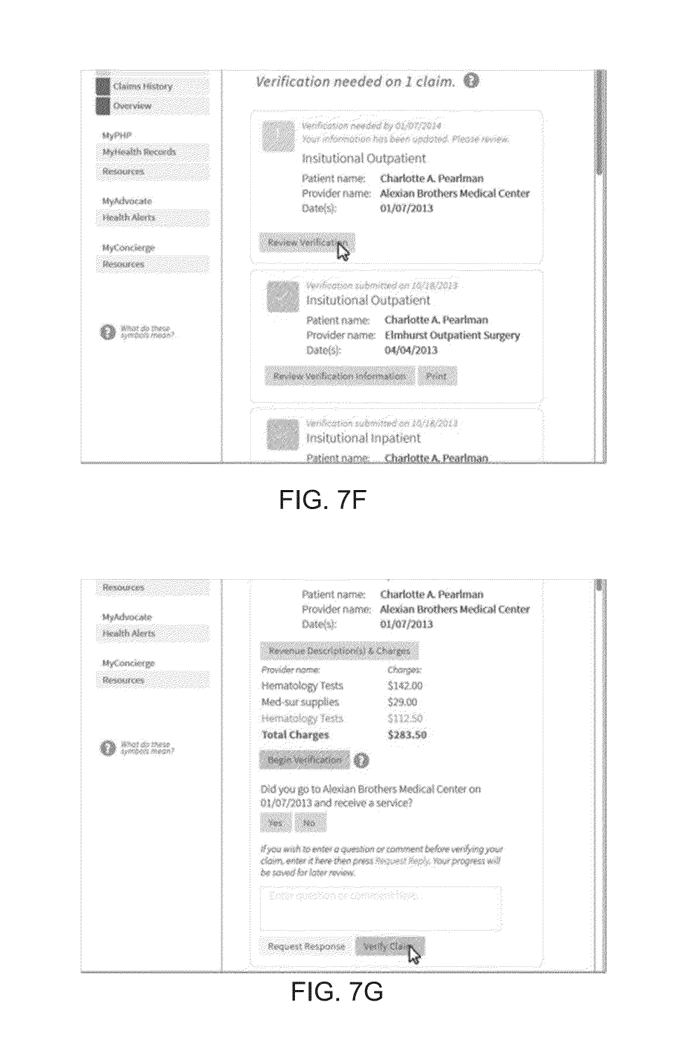

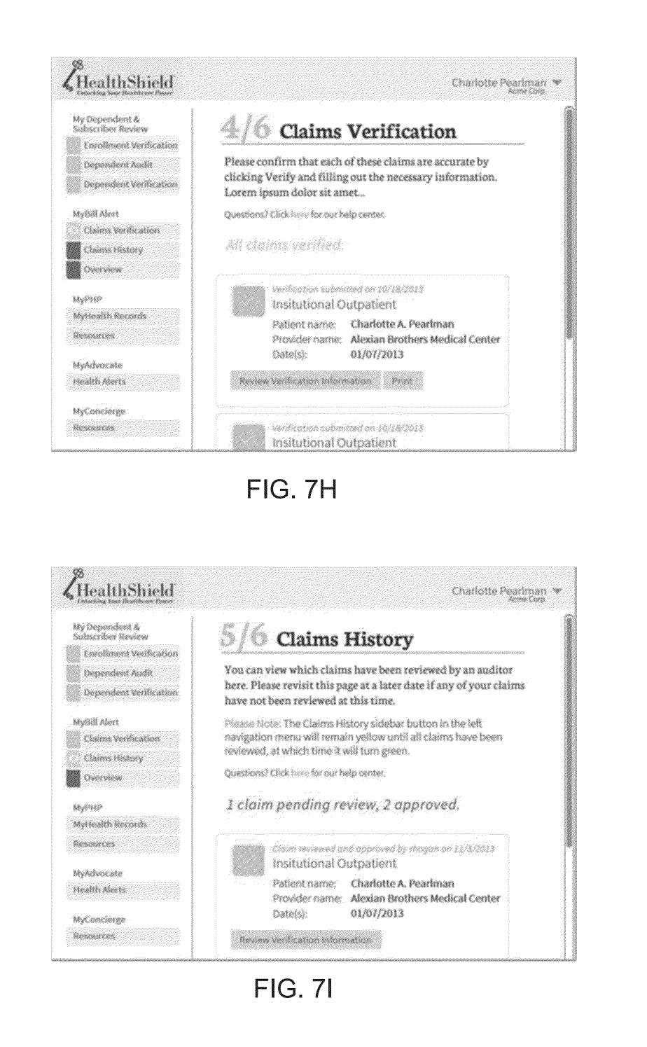

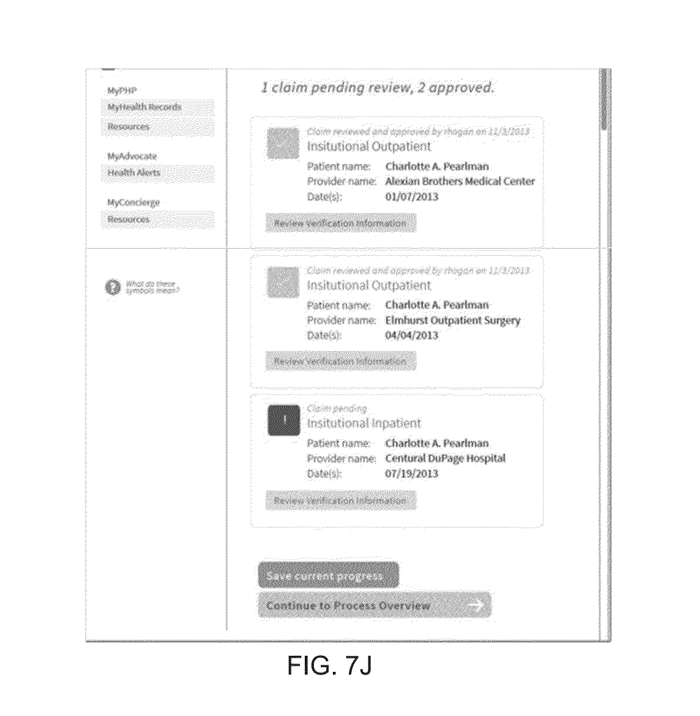

FWA-IIRB Model, Framework, and Analytic Roadmap
Computer system provides and user validates the selection and/or creates relevant industry revenue cycle component(s) (see FIG. 5)
Computer system provides and user validates Mortgage Banking Revenue Cycle
Computer system provides and the user validates current and updated components of revenue cycle-system compares to data base and or new data inputs and progresses in the accumulation of data for interim outputs leading towards final out.

Initiate Model of FIG. 1:
Computer system input of Players and validated by user: Bank refusing checking account; Female Spouse; Male Spouse; homestead residence; residence Mortgage Company. Computer system conducts a human and entity capital analysis and feeds aggregated data pool of case.
Computer system input of Benchmarks and validated by user—user receives incremental output for progressive analysis
   Bank refusing checking account (a central bank with the Office of the Comptroller of the Currency (OCC) as governing authority)—computer system ties data back to original continuum components and feeds aggregated data pool of case.
   Female Spouse (homemaker, no independent credit cards or checking account, signer on loan) and feeds aggregated data pool of case—computer system ties data back to original continuum components and feeds aggregated data pool of case.
   Homestead residence (purchased by both spouses for $600,000, current note on house $1.7 million)—computer system ties data back to original continuum components and feeds aggregated data pool of case.
   Resident Mortgage Company (central bank) and feeds aggregated data pool of case—computer system ties data back to original continuum components and feeds aggregated data pool of case.
   Mortgage equity loan exceed market value by $1 million and feeds aggregated data pool of case—computer system ties data back to original continuum components and feeds aggregated data pool of case. User validates findings.

Integrate Framework of FIG. 2:
Computer system input of Transparency components and validated by user: Victim did not recognize her signature on the mortgage document—source of signature not known. Computer system conducts a human and entity capital analysis and feeds aggregated data pool of case.
Discoverable Gap: copies of mortgage documents demonstrate produced have a false signature of female spouse. Computer system output is validated by user.
   Aggregation of Data Drivers (computer system ties data back to original continuum components and feeds aggregated data pool of case)
      Player: Notary of mortgage documents. User validates findings.
   Aggregation of Data Drivers (computer system ties data back to original continuum components and feeds aggregated data pool of case)
      Benchmark: Notary (The Notary Public Code of Professional Responsibility). User validates findings.
   Aggregation of Data Drivers (computer system ties data back to original continuum components and feeds aggregated data pool of case)
      Rule: Notary Deal requirements of Ill. Comp. Stat. §3-101. User validates findings.
   Aggregation of Data Drivers (computer system ties data back to original continuum components and feeds aggregated data pool of case)
      Functional information component: notary was a high school friend of both spouses; did not witness victim sign mortgage. User validates findings.

Integrate Data Drivers of FIG. 3:
Discoverable Gap: Notary did not witness signature of victim. Computer system output is validated by user.
   Aggregation of Data Drivers (computer system ties data back to original continuum components and feeds aggregated data pool of case)
      Player: review of male spouse—now alleged perpetrator. User validates findings.
   Aggregation of Data Drivers (computer system ties data back to original continuum components and feeds aggregated data pool of case)
      Consequence: Victim was represented as financial guarantor for an unknown series of equity lines. User validates findings.
   Aggregation of Data Drivers (computer system ties data back to original continuum components and feeds aggregated data pool of case)
      Functional information: found 5 supplemental equity lines. User validates findings.
   Aggregation of Data Drivers (computer system ties data back to original continuum components and feeds aggregated data pool of case)
      All transactions involved same broker and real estate appraiser. User validates findings.
   Aggregation of Data Drivers (computer system ties data back to original continuum components and feeds aggregated data pool of case)
      Player: added broker & appraiser. User validates findings.
   Aggregation of Data Drivers (computer system ties data back to original continuum components and feeds aggregated data pool of case)
      Benchmark: broker & appraiser (department of professional regulation). User validates findings.
Discoverable gap: value of home could not be substantiated; perpetrator deposited equity line loans into a separate account unknown by the victim. Perpetrator exhausted his own credit—then utilized spouse for ongoing credit. Computer system output is validated by user.
   Aggregation of Data Drivers (computer system ties data back to original continuum components and feeds aggregated data pool of case)
      Consequence: Victim credit score damaged from unknown loans and unauthorized use of identity by perpetrator. User validates findings.

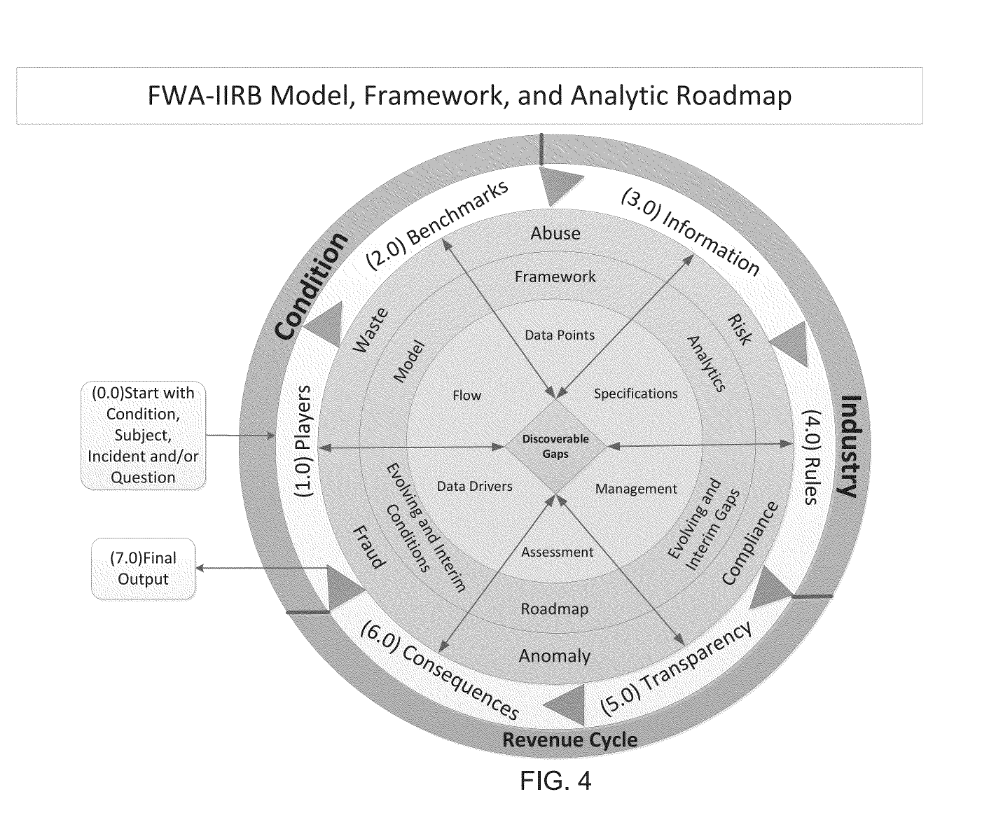

Integrate Model, Framework, and Analytic Roadmap of FIG. 4:
Computer system input of Interactive, Iterative, Reiterating Analytic Model and Framework integration of data points and validated by user:
   Computer system input and processing of Aggregation of Data Drivers (computer system ties data back to original continuum components and feeds aggregated data pool of case)
      Players: Bank refusing checking account; Female Spouse; Male Spouse; homestead residence; residence Mortgage Company; Notary of mortgage documents; review of male spouse—now alleged perpetrator; added broker & appraiser User validates findings.
   Computer system input and processing of Aggregation of Data Drivers (computer system ties data back to original continuum components and feeds aggregated data pool of case)
      Benchmarks: Bank refusing checking account (a central bank with the OCC as governing authority); Female Spouse (homemaker, no independent credit cards or checking account, signer on loan); Homestead residence (purchased by both spouses for $600,000, current note on house $1.7 million); Resident Mortgage company (central bank); Notary (The Notary Public Code of Professional Responsibility); broker & appraiser (department of professional regulation). User validates findings.
   Computer system input and processing of Aggregation of Data Drivers (computer system ties data back to original continuum components and feeds aggregated data pool of case)
      Functional information component: notary did not witness victim signature, high school friend of both spouses; Functional information: found 5 supplemental equity lines; All transactions involved same broker and real estate appraiser. User validates findings.
   Computer system input and processing of Aggregation of Data Drivers (computer system ties data back to original continuum components and feeds aggregated data pool of case)
      Rule: Notary Deal requirements of Ill. Comp. Stat. §3-101; Central Banking Rules. User validates findings.
   Computer system input and processing of Aggregation of Data Drivers (computer system ties data back to original continuum components and feeds aggregated data pool of case)
      Transparency: Victim did not recognize her signature on the mortgage document—source of signature not known. User validates findings.
   Computer system input and processing of Aggregation of Data Drivers (computer system ties data back to original continuum components and feeds aggregated data pool of case)
      Consequence: Victim was represented as financial guarantor for an unknown series of equity lines; Consequence: Victim credit score damaged from unknown loans and unauthorized use of identity by perpetrator. User validates findings.
   Computer system input and processing of Interim Output(s):
      Aggregation of Data Drivers (computer system ties data back to original continuum components and feeds aggregated data pool of case)
         Discoverable Gap: copies of mortgage documents produced have a false signature of female spouse; computer system output is validated by user.
      Aggregation of Data Drivers (computer system ties data back to original continuum components and feeds aggregated data pool of case)
         Discoverable Gap: Notary did not witness signature of victim; computer system output is validated by user.
      Aggregation of Data Drivers (computer system ties data back to original continuum components and feeds aggregated data pool of case)
         Discoverable gap: value of home could not be substantiated; perpetrator deposited equity line loans into a separate account unknown by the victim. Perpetrator exhausted his own credit—then utilized spouse for ongoing credit. Computer system output is validated by user.
   Computer system input and processing of Final Output(s):
      Aggregated of Data Drivers (computer system ties data back to original continuum components and feeds aggregated data pool of case)
         Perpetrator colluded with broker and real estate appraiser to strip homestead equity in excess of $1.2 million dollars; upon exhaustion of personal credit utilized a familiar notary as the mechanism of theft (victim identity) on mortgage documents to continue mortgage equity stripping scheme. User validates findings.

The FWA-IIRB Model and Framework of the present invention is unique because it is not a one-size fits all approach. It is comprehensive and facilitates analysis of different types of fraud cases in different ways. For example—a banking mortgage loan fraud by a buyer is totally different from an insurance claim fraud by a provider. The model automatically determines the approach based on a wide variety of parameters. For example, the approach taken may depend on an “industry” parameter, such as whether the industry relevant to the investigation is banking or healthcare. Likewise the primary player determination is important for effective and efficient findings—for example, suspected fraudulent use of an insurance plan by a subscriber may be approached differently than the same by a healthcare provider. In addition to the above, the FWA-IIRB is comprehensive in data collection and effective in handling a wide variety of situations, players and industries. The details and data captured will determine a path or paths for the algorithm or data flow to follow. Simultaneously, the system builds data volume by creating additional data points and discovering gaps as the model/framework proceeds to final output/results. By tailoring the analysis algorithm to the type and content of the data provided to the system, the invention improves a computer's speed and efficiency in processing the data and supplying a result.

While the invention has been described with respect to certain embodiments, as will be appreciated by those skilled in the art, it is to be understood that the invention is capable of numerous changes, modifications and rearrangements, and such changes, modifications and rearrangements are intended to be covered by the following claims.

What is claimed is:

1. A system for identifying fraud, waste, and abuse in an industry, comprising:
a plurality of industry computer devices deployed in the industry; and
a server communicatively linked to the plurality of industry computer devices, the server configured to receive data inputs pertaining to a case from each of the plurality of computer devices and programmed to sort the data inputs into one or more applicable behavioral continuum components of a framework comprising a plurality of behavioral continuum components, each behavioral continuum component communicatively linked to each of a plurality of databases, each behavioral continuum component being programmed to further sort the data inputs pertaining to the respective behavioral component into one or more of the plurality of databases, the server being programmed to tie data from the plurality of databases back to the behavioral continuum components, to aggregate the data into a pooled database of the case, to identify an abnormal data point or a discoverable gap in the pooled database, and to alert a user of one or more of the industry computer devices to the abnormal data point or discoverable gap.

2. The system of claim 1, the behavioral continuum components comprising programmed instructions executed by a processor of the server.

3. The system of claim 1, the discoverable gap comprising an expected data point that is missing from the pooled database.

4. The system of claim 3, the server being programmed to automatically identify the expected missing data point as being associated with one or more of the data inputs according to a relational rule stored in a memory device of the server.

5. The system of claim 4, the relational rule being manually coded into the server memory.

6. The system of claim 4, the relational rule being learned by the server in the process of implementing the system in one or more previous cases.

7. The system of claim 1, the behavioral continuum components comprising a primary players component, a benchmarks component, a functional information component, a rules-based component, a transparency component, and a consequence component.

8. The system of claim 1, the databases comprising an activities of daily living flows database, an activities of daily workflows database, and industry data points data base, a revenue cycle data points database, an operational data points database, a product data points database, a service data points database, a prevention, detection, and mitigation workflows database, and a player data points database.
